(19) United States
(12) Patent Application Publication
(10) Pub. No.: US 2026/0216854 A1
(43) Pub. Date: Jul. 30, 2026

(54) Demolition Hammer with Two Side Handles

(71) Applicant: Robert Bosch GmbH, Stuttgart (DE)

(72) Inventor: Immanuel Werner, Bad Urach (DE)

(21) Appl. No.: 19/458,744

(22) Filed: Jan. 24, 2026

(30) Foreign Application Priority Data
Jan. 29, 2025 (DE) 10 2025 103 229.7

(51) Int. Cl. B25D 17/04

(52) U.S. Cl. CPC B25D 17/043; B25D 2217/0073; B25D 2250/371

(57) ABSTRACT

A demolition hammer has a housing, on which two handles are each laterally arranged and are rigidly connected to each other via a splined shaft. The two handles are pivotable about the splined shaft on the housing. An anti-vibration system is provided with at least one metallic spring element. The at least one metallic spring element is operatively connected to the splined shaft and applies force to the two handles to push them into an associated rest position.

This application claims priority under 35 U.S.C. § 119 to patent application no. DE 10 2025 103 229.7, filed on Jan. 29, 2025 in Germany, the disclosure of which is incorporated herein by reference in its entirety.

### BACKGROUND

The present disclosure relates to a demolition hammer having a housing, on which two handles are each laterally arranged and are rigidly connected to each other via a splined shaft, wherein the two handles are pivotable about the splined shaft on the housing.

Such a demolition hammer is known from prior art. The demolition hammer comprises a housing, on which two handles are each laterally arranged. The handles are rigidly connected to each other via a splined shaft, wherein the two handles are pivotally arranged about the splined shaft on the housing.

### SUMMARY

The disclosure relates to a demolition hammer having a housing, on which two handles are each laterally arranged and are rigidly connected to each other via a splined shaft, wherein the two handles are pivotable about the splined shaft on the housing. An anti-vibration system is provided with at least one metallic spring element, wherein the at least one metallic spring element is operatively connected to the splined shaft and applies force to the two handles to push them into an associated rest position.

The disclosure thus allows the provision of a demolition hammer, in which a stable and robust anti-vibration system can be provided by way of the at least one metallic spring element, whereby the service life of the demolition hammer can advantageously be increased. Furthermore, by way of the design of the anti-vibration system with the metallic spring element, very accurate adjustment of the anti-vibration system can be achieved via a spring characteristic associated with the spring element.

Preferably, the housing comprises at least one support section with a conical inner receptacle, wherein a support sleeve is fixed in the conical inner receptacle, in which sleeve a pivot bearing is arranged, and wherein the splined shaft is rotatably supported in the pivot bearing.

Thus, secure and reliable support of the splined shaft in the housing can be achieved.

Preferably, the pivot bearing is arranged along a longitudinal extension of the housing in the housing.

A compact arrangement of the pivot bearing can thus be made possible in a simple manner.

The conical inner receptacle preferably comprises a plurality of radially inwardly facing ribs that extend along a longitudinal extension of the splined shaft.

Thus, a support sleeve can be easily and straightforwardly supported in the conical inner receptacle.

Preferably, each of the two handles is respectively connected to the splined shaft via an associated intermediate plate, wherein each intermediate plate comprises a recess with internal toothing, and wherein the splined shaft has external toothing on its outer circumference, which forms interlocking fits with the internal toothing.

Thus, a connection of the intermediate shaft with the associated intermediate plates of the handles can be facilitated in a simple manner.

Preferably, each intermediate plate comprises a first recess and a second oppositely located recess, and that at least one damping element fixed to the housing is provided, wherein the damping element fixed to the housing is arranged in the first recess in the rest position of the two handles and is arranged in the second recess in an end position of the two handles into which the two handles are moved by pivoting about the splined shaft.

Thus, a secure and reliable arrangement of the two handles can be achieved in the rest position and the end position.

A guide contour is preferably provided for guiding the two handles from the rest position to the end position and vice versa.

Thus, guided pivoting of the two handles can be facilitated in a simple manner.

Preferably, a spacer bushing is arranged along a longitudinal extension of the splined shaft between the intermediate plate of at least one of the two handles and the pivot bearing, wherein the metallic spring element is a leg spring, which is arranged on an outer circumference of the spacer bushing, wherein a first leg of the leg spring is arranged on the housing, and wherein a second leg of the leg spring is arranged on at least one of the two handles.

This makes it easy and straightforward to provide a suitable metallic spring element.

According to one embodiment, an interlocking fit is formed between the first leg of the leg spring and the housing and/or the second leg of the leg spring and a handle.

Thus, a secure and reliable arrangement of the leg spring on the housing and/or on the handle can be achieved.

According to one embodiment, a connecting rod is arranged along a longitudinal extension of the splined shaft between the intermediate plate of at least one of the two handles and the pivot bearing, which is rotatably connected to the splined shaft at a shaft receiving region and comprises a spring holder region spaced apart from the shaft receiving region by way of a connecting section, wherein the metallic spring element is arranged on the housing and on the spring holder region.

An alternative arrangement of the metallic spring element can thus be achieved.

Preferably, the metallic spring element is a compression spring or a tension spring.

Thus, a suitable spring element for an alternative arrangement of the metallic spring element may be provided in a simple manner.

Preferably, the metallic spring element configured as a leg spring or the metallic spring element configured as a tension spring is arranged on the housing by way of a spring holder.

A simple and reliable arrangement of the metallic spring element on the housing can thus be achieved.

Preferably, the anti-vibration system with the at least one metallic spring element is arranged within a housing cover.

Thus, a simple and secure arrangement of the anti-vibration system in the demolition hammer can be achieved.

Preferably, a longitudinal extension of a drive shaft associated with a drive motor for operating a tool holder is arranged perpendicularly to a longitudinal extension of the splined shaft.

A compact arrangement of the drive motor can thus be achieved.

### BRIEF DESCRIPTION OF THE DRAWINGS

The disclosure is explained in more detail in the following description with reference to the exemplary embodiments shown in the drawings. It shows:

FIG. 1 a perspective view of a demolition hammer with an anti-vibration system,

FIG. 2 a perspective view of the demolition hammer of FIG. 1 to illustrate the anti-vibration system of FIG. 1,

FIG. 3 an enlarged view of a handle associated with the demolition hammer of FIG. 1 and FIG. 2 with the anti-vibration system of FIG. 1 and FIG. 2,

FIG. 4 a side view of the anti-vibration system from FIG. 1 through FIG. 3 in a rest position,

FIG. 5 a side view of the anti-vibration system from FIG. 1 through FIG. 4 in an end position,

FIG. 6 a longitudinal section through a splined shaft associated with the anti-vibration system of FIG. 1 through FIG. 5, which shaft is connected to handles of the demolition hammer of FIG. 1 through FIG. 4,

FIG. 7 a perspective view of a housing associated with the demolition hammer of FIG. 1 and FIG. 2,

FIG. 8 a perspective view of a splined shaft of the anti-vibration system of FIG. 1 through FIG. 6,

FIG. 9 a perspective view of an intermediate plate associated with the anti-vibration system of FIG. 1 through FIG. 6,

FIG. 10 a perspective view of an alternative anti-vibration system of the demolition hammer of FIG. 1 through FIG. 6,

FIG. 11 an enlarged sectional view through the anti-vibration system of FIG. 10,

FIG. 12 a perspective view of a connecting rod associated with the anti-vibration system of FIG. 10 and FIG. 11,

FIG. 13 a perspective view of a spring stop associated with the anti-vibration system of FIG. 10 and FIG. 11 when viewed in a first direction,

FIG. 14 a perspective view of the spring stop of FIG. 13 associated with the anti-vibration system of FIG. 10 and FIG. 11 when viewed in a second direction,

FIG. 15 an enlarged view of a housing of the demolition hammer of FIG. 1 through FIG. 6 associated with the anti-vibration system of FIG. 10 and FIG. 11,

FIG. 16 a perspective view of a tooth hub associated with the anti-vibration system of FIG. 10 and FIG. 11,

FIG. 17 a perspective view of an alternative anti-vibration system of the demolition hammer of FIG. 1 through FIG. 6,

FIG. 18 an enlarged view of the anti-vibration system of FIG. 17,

FIG. 19 a perspective view of a connecting rod associated with the anti-vibration system of FIG. 17 and FIG. 18,

FIG. 20 an enlarged view of a housing associated with the anti-vibration system of FIG. 17 and FIG. 18,

FIG. 21 a perspective view of a spring holder associated with the anti-vibration system of FIG. 17 and FIG. 18,

FIG. 22 a top plan view of a flange associated with a handle of the demolition hammer of FIG. 1 through FIG. 6, and the intermediate plate of FIG. 9, wherein the flange comprises a guide contour,

FIG. 23 a top plan view of the flange of FIG. 22 to illustrate the guide contour of FIG. 22,

FIG. 24 a perspective view of the handle mounted on the housing of the demolition hammer of FIG. 1 through FIG. 6 with the flange of FIG. 22 and FIG. 23,

FIG. 25 a perspective view of the handle with the flange and the intermediate plate of FIG. 22 and FIG. 23 with a spring holder section,

FIG. 26 a top plan view of the flange and the intermediate plate of the handle of FIG. 25,

FIG. 27 a perspective view of a handle of the demolition hammer of FIG. 1 through FIG. 6 with the flange of FIG. 22 through FIG. 26, which comprises an alternative spring holder section,

FIG. 28 a perspective view of the handle with the flange of FIG. 27,

FIG. 29 a perspective view of the intermediate plate of FIG. 27,

FIG. 30 a top plan view of the anti-vibration system of the demolition hammer of FIG. 1 through FIG. 6 with an alternative spring holder section arranged on the housing of the demolition hammer,

FIG. 31 a top plan view of the anti-vibration system of FIG. 30 with the spring holder section of FIG. 30 arranged on the housing and the spring holder section of FIG. 27 arranged on the flange,

FIG. 32 a top plan view of the anti-vibration system of the demolition hammer of FIG. 1 through FIG. 6 with an alternative spring holder section arranged on the housing of the demolition hammer, and

FIG. 33 an enlarged view of the housing of the demolition hammer of FIG. 1 through FIG. 6 to illustrate the spring holder section of FIG. 32.

### DETAILED DESCRIPTION

Elements having the same or a comparable function are provided with the same reference signs in the figures and are described in detail only once.

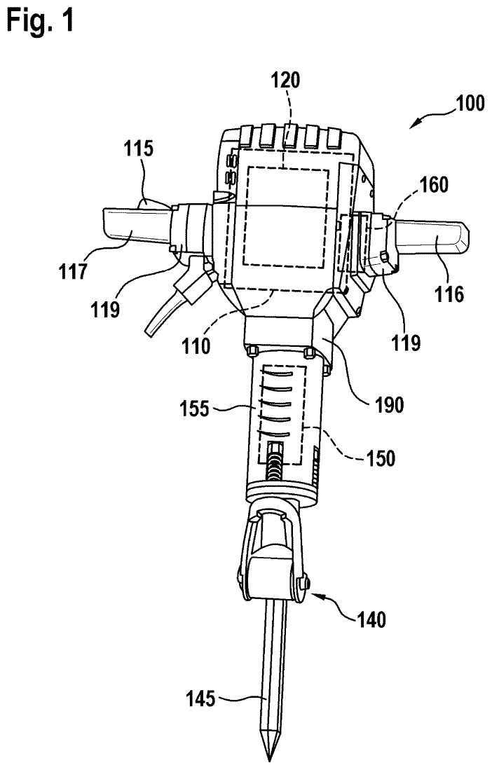

FIG. 1 illustrates an exemplary demolition hammer 100 with a percussion mechanism unit 150 and a tool holder 140 configured to receive an insertion tool 145, in particular a chisel insertion tool. The demolition hammer 100 exemplarily has a housing 110, which is preferably configured as a cast part, in which no machining rework is required.

Illustratively, a drive motor 120 is provided in the housing 110 of the demolition hammer 100 to operate the insertion tool 145 arranged in the tool holder 140. Preferably, the demolition hammer 100 comprises two handles 116, 117, via which the demolition hammer 100 is held and guided by a user. The two handles 116, 117 are arranged diametrically opposite on the housing 110. For arrangement on the housing 110, each of the handles 116, 117 is associated with a flange 119, which preferably comprises plastic to improve electrical safety. Illustratively, the handle 117 is associated with an operating element 115 for activating the drive motor 120.

The drive motor 120 is preferably configured to drive the percussion mechanism unit 150. The percussion mechanism unit 150 is associated with an optional percussion mechanism housing 155.

Furthermore, the demolition hammer 100 illustratively comprises a housing cover 190. Preferably, the drive motor 120 and/or the percussion mechanism unit 150, or the housing 110 and/or the optional percussion mechanism housing 155, are arranged at least in sections in the housing cover 190.

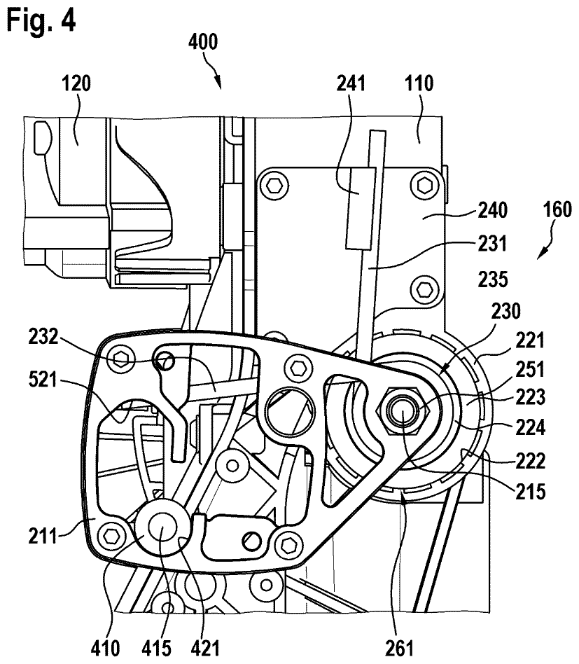

According to the disclosure, an anti-vibration system 160 is provided. The anti-vibration system 160 is preferably associated with the two handles 116, 117. The anti-vibration system 160 is configured to apply pressure to the two handles 116, 117 to move them into an associated rest position (400 in FIG. 4).

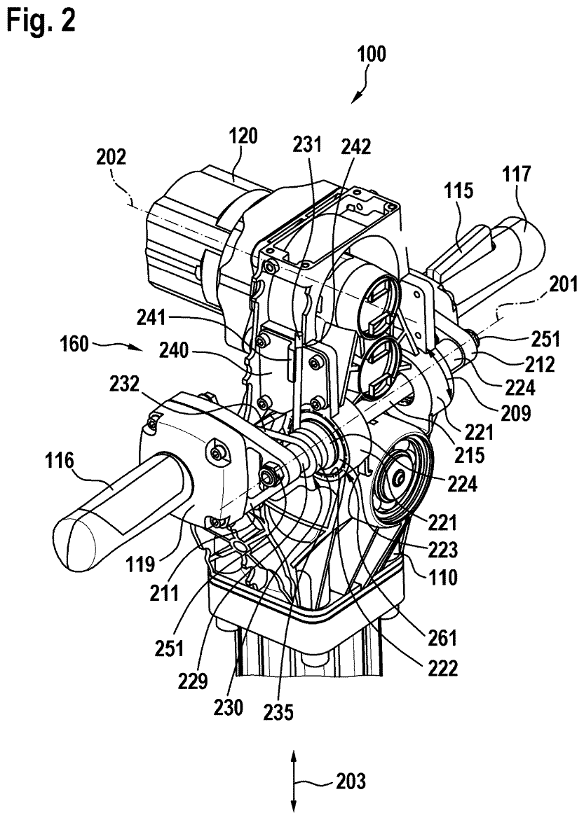

FIG. 2 shows the demolition hammer 100 of FIG. 1 without the housing cover 190 of FIG. 1. FIG. 2 illustrates the housing 110 with the drive motor 120 as well as the handles 116, 117 and the associated anti-vibration system 160. The two handles 116, 117 are preferably each arranged laterally on the housing 110, wherein the handle 116 is illustratively arranged to the left of the drive motor 120 and the handle 117 is illustratively arranged to the right of the drive motor 120. The two handles 116, 117 are rigidly connected to each other via a splined shaft 215. The two handles 116, 117 can be pivoted about the splined shaft 215 on the housing 110. When pivoted, the splined shaft 215 rotates illustratively in the circumferential direction 209.

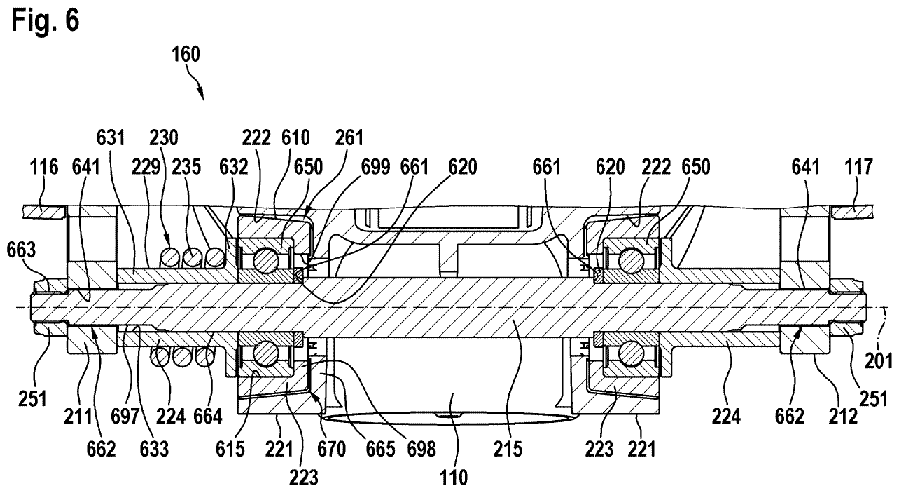

Preferably, the housing 110 comprises at least one support section 221 for supporting the splined shaft 215. At least one pivot bearing (650 in FIG. 6) is associated with the splined shaft 215 for rotational support. Preferably, the at least one support section 221 is associated with an inner receptacle 222 in which the pivot bearing (650 in FIG. 6) is arranged. Preferably, the inner receptacle 222 is conical. In the inner receptacle 222, a support sleeve 223 is preferably fixed to receive the pivot bearing (650 in FIG. 6). Illustratively, two support sections 221 are provided, wherein each support section 221 is associated with one of the handles 116, 117. According to one embodiment, the support section 221 or pivot bearing (650 in FIG. 6) is arranged along a longitudinal extension 203 of the housing 110 in the housing 110.

Preferably, the inner receptacle 222 comprises a plurality of radially inwardly facing ribs 261. The ribs 261 extend illustratively along a longitudinal extension 201 of the splined shaft 215.

Furthermore, preferably each of the two handles 116, 117 is connected to the splined shaft 215 via an associated intermediate plate 211, 212. Preferably, the intermediate plates 211, 212 are formed as sintering parts and comprise metal, in particular steel. The intermediate plates 211, 212 are, by way of example, each fixed by way of a nut 251 at an axial end of the splined shaft 215. The intermediate plate 211 is illustratively associated with the handle 116, and the intermediate plate 212 is illustratively associated with the handle 117.

Moreover, preferably, a spacer bushing 224 is arranged along each longitudinal extension 201 of the splined shaft 215 between an intermediate plate 211, 212 and the support section 221 or the pivot bearing (650 in FIG. 6). Each spacer bushing 224 preferably comprises plastic.

According to the disclosure, the anti-vibration system 160 comprises at least one metallic spring element 230. The at least one metallic spring element 230 is preferably operatively connected to the splined shaft 215 and is configured to apply pressure to the two handles 116, 117 to push them into an associated rest position (400 in FIG. 4), or to hold them in the rest position through spring tension. Illustratively, a metallic spring element 230 is associated with the handle 116. Alternatively, the metallic spring element 230 may also be associated with the handle 117.

According to one embodiment, the metallic spring element 230 is a leg spring 235. The leg spring 235 is illustratively arranged on an outer circumference 229 of the spacer bushing 224. A first leg 231 of the leg spring 235 is preferably arranged on the housing 110, and a second leg 232 of the leg spring 235 is arranged on, for example, one of the two handles 116, 117. Illustratively, the second leg 232 is arranged on the second handle 116.

For arrangement of the first leg 231 on the housing 110, a spring holder 240 is preferably associated with the housing 110. Preferably, the spring holder 240 is attached to the housing 110. For example, the spring holder 240 is fixed to the housing 110 by way of a screw connection. Alternatively, the spring holder 240 is formed integrally with the housing 110. Preferably, the spring holder 240 comprises plastic.

The spring holder 240 preferably comprises an abutment element 241, against which the leg 231 abuts. Preferably, the abutment element 241 comprises a receptacle 242 for receiving the leg 231. Illustratively, the leg spring 235 or the legs 231, 232 have a circular cut. Preferably, the receptacle 242 of the abutment element 241 has a shape associated with the leg 231.

Preferably, a longitudinal extension 202 of a drive shaft associated with drive motor 120 for operating the tool holder 140 is arranged perpendicularly to the longitudinal extension 201 of the splined shaft 215. The drive motor 120 is illustratively arranged on side of the splined shaft 215 facing away from the user.

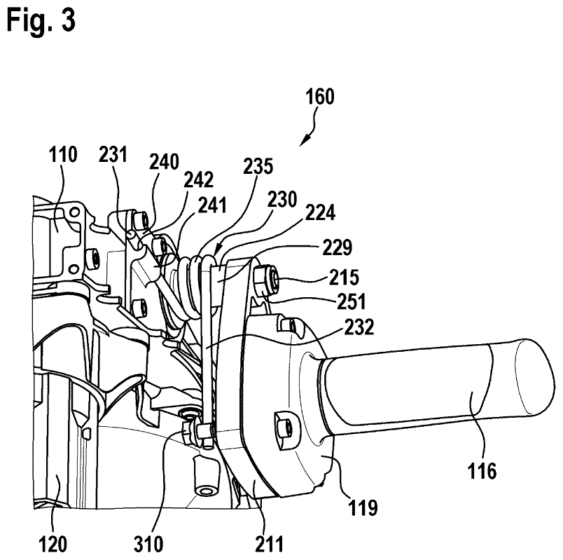

FIG. 3 shows the handle 116 of FIG. 1 and FIG. 2 of the demolition hammer 100 of FIG. 1 and FIG. 2 with the anti-vibration system 160 of FIG. 1 and FIG. 2 and leg spring 235 of FIG. 2. FIG. 3 illustrates the arrangement of the leg spring 235, in which the first leg 231 is arranged in the receptacle 242 of the abutment element 241 of the spring holder 240 and the second leg 232 abuts an abutment element 310 associated with the handle 116. Preferably, the abutment element 310 is attached to the intermediate plate 211 of the handle 116. The abutment element 310 is configured as a screw, by way of example.

FIG. 4 shows the intermediate plate 211 of FIG. 2 and FIG. 3 of the handle 116 of FIG. 1 through FIG. 3 with the anti-vibration system 160 of FIG. 2 and FIG. 3 in a rest position 400 of the handle 116, wherein the flange 119 of FIG. 1 through FIG. 3 and the handle 116 in FIG. 1 through FIG. 3 are not shown. FIG. 4 illustrates intermediate plate 211 illustratively having a first recess 421 and a second oppositely located recess 521.

Preferably, at least one damping element 410 fixed to the housing is provided. The damping element 410 is preferably arranged on a housing bar 415 of the housing 110. The damping element 410 is preferably formed integrally with the housing bar 415 of the housing 110. The damping element 410 fixed to the housing is preferably arranged in the first recess 421 of the intermediate plate 211 in the rest position 400. The damping element 410 preferably comprises PU foam or an elastomer. Preferably, the configuration of the recesses 421, 521 prevents the damping element 410 from slipping down from the housing bar 415.

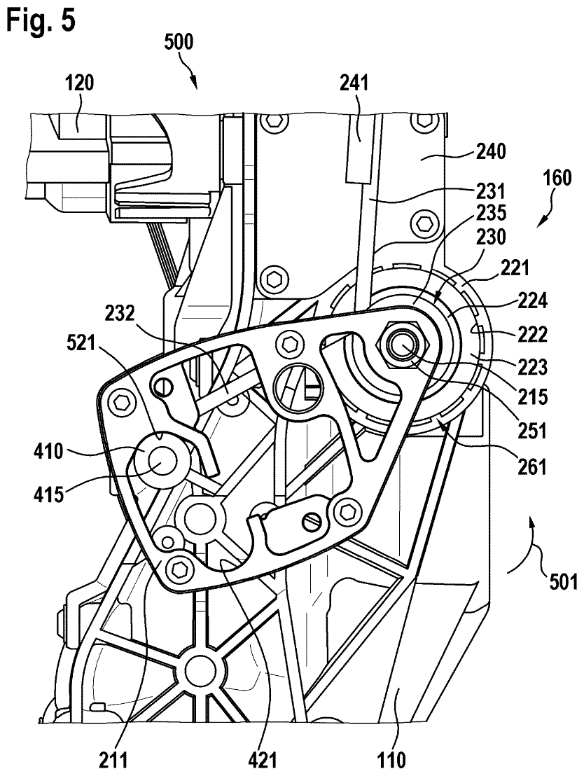

FIG. 5 shows the intermediate plate 211 of FIG. 2 through FIG. 4 of the handle 116 of FIG. 1 through FIG. 3 with the anti-vibration system 160 of FIG. 2 through FIG. 4 in an end position 500. In the end position 500, the two handles 116, 117 are arranged pivoted towards an arrow 501 with the splined shaft 215 about the longitudinal extension 201 of the splined shaft 215. The damping element 410 fixed to the housing is arranged in the second recess 521 of the intermediate plate 211.

FIG. 6 shows the splined shaft 215 of FIG. 2, FIG. 4, and FIG. 5 arranged in the housing 110 of FIG. 1 through FIG. 5 with the two handles 116, 117 and the anti-vibration system 160 of FIG. 2 through FIG. 5. FIG. 6 illustrates the mounting of the splined shaft 215 in the housing 110.

As already described above, preferably, the splined shaft 215 is supported in the housing 110 via at least one pivot bearing 650, illustratively two pivot bearings 650. The pivot bearings 650 are preferably arranged in the at least one support section 221, in particular the inner receptacle 222 of the housing 110 and the support section 221 of the housing 110. Illustratively, the housing 110 comprises two oppositely located support sections 221.

The pivot bearings 650 are preferably each associated with a support sleeve 223. The support sleeve 223 is illustratively arranged in the inner receptacle 222. For example, the pivot bearing 650 is arranged in an inner receptacle 615 of the support sleeve 223.

The support sleeve 223 preferably has a conical base body having a bottom surface 698 and the inner receptacle 615, as well as a conical outer circumference 610 associated with the inner receptacle 222. The conical outer circumference 610 of the support sleeve 223 is illustratively partially abutting the radially inwardly facing ribs 261 of the inner receptacle 222. The bottom surface 698 preferably forms a contact surface for the pivot bearing 650 and preferably has a recess 699. The inner receptacle 222 preferably comprises an abutment collar 665, against which the support sleeve 223 abuts. Preferably, tolerance compensation takes place at a location 670 between the bottom surface 698 of the support sleeve 223 and the abutment collar 665.

Furthermore, preferably a retaining ring 620 is arranged along the longitudinal extension 201 of the splined shaft 215 between the pivot bearing 650 and an abutment edge 661 of the splined shaft 215. Illustratively, the retaining ring 620 is arranged coaxially with the recess 699 of the support sleeve 223.

The pivot bearing 650 is illustratively arranged on a support section 664 of the splined shaft 215. Also, the spacer bushing 224 is arranged at least in portions in the support section 664. The spacer bushing 224 preferably comprises a cylindrical base body 631 having an inner receptacle 633 as well as a circumferential collar 632 facing the pivot bearing 650. The circumferential collar 632 presses the pivot bearing 650 into the inner receptacle 222.

The support section 664 of the splined shaft 215 illustratively tapers in the direction of the free end of the splined shaft 215 into a toothing section 697. The toothing section 697 preferably includes external toothing 662. The intermediate plate 211 preferably comprises internal toothing (911 in FIG. 9) associated with the external toothing 662 and a recess 641 of the intermediate plate 211. The external toothing 662 of the splined shaft 215 and the internal toothing (911 in FIG. 9) of the intermediate plate 211 are preferably operatively connected.

The toothing section 697 of the splined shaft 215 tapers exemplarily in the direction of the free end of the splined shaft 215 into a threaded section 663. Illustratively, the nut 251 is arranged on the threaded section 663. The nut 251 presses the intermediate plate 211 against the spacer bushing 224, which again presses the pivot bearing 650 into the inner receptacle 615 and thus into the inner receptacle 222 of the support sleeve 223. The tensioning preferably provides a play-free fit between the nut 251, the intermediate plate 221, the spacer bushing 224, the pivot bearing 650, and the housing 110 or the inner receptacle 222 respectively.

Preferably, a support section 221 or pivot bearing 650 is arranged along the longitudinal extension 201 of the splined shaft 215 centrally within the housing 110.

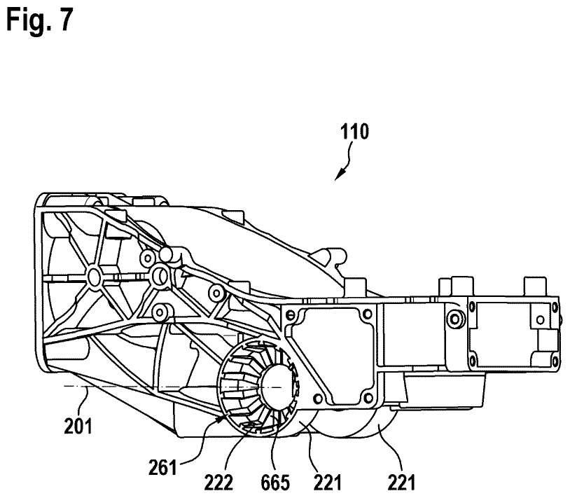

FIG. 7 shows the housing 110 of FIG. 1 through FIG. 6 of the demolition hammer 100 of FIG. 1 through FIG. 2 and illustrates the inner receptacle 222 of FIG. 2 and FIG. 4 through FIG. 6 with the plurality of radially inwardly facing ribs 261 of FIG. 2 and FIG. 4 through FIG. 6 extending along the longitudinal extension 201 of the splined shaft 215 of FIG. 2 through FIG. 6.

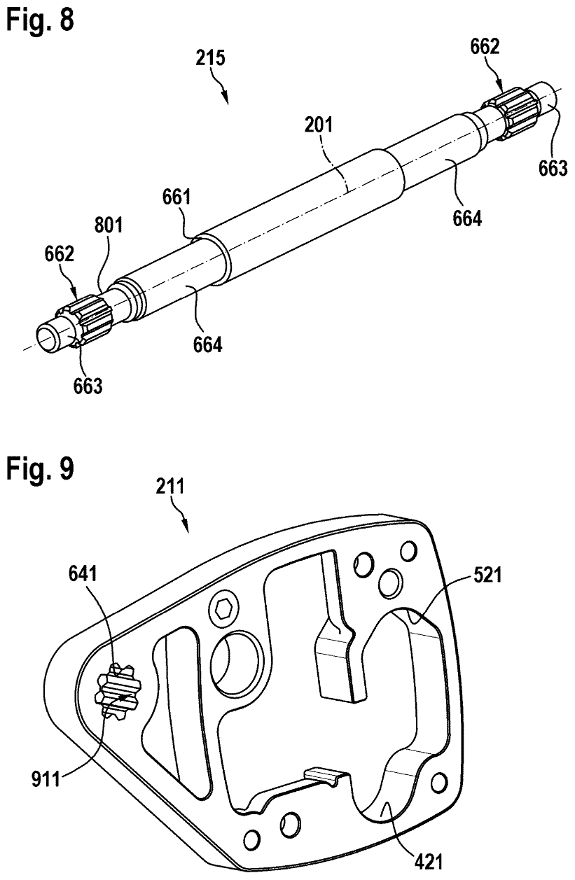

FIG. 8 shows the splined shaft 215 of FIG. 2 through FIG. 6 with the abutment edge 661 of FIG. 6, the support section 664 of FIG. 6, the external toothing 662 of FIG. 6, and the threaded section 663 of FIG. 6. The external toothing 662 is illustratively arranged on the outer circumference 801 of the splined shaft 215 of FIG. 2 through FIG. 6.

FIG. 9 shows the intermediate plate 211 of FIG. 2 through FIG. 6 with the first recess 421 of FIG. 4 and FIG. 5 and the second oppositely located recess 521 of FIG. 4 and FIG. 5. Furthermore, FIG. 9 illustrates the recess 641 of FIG. 6 with the internal toothing 911 of FIG. 9. The internal toothing 911 preferably forms interlocking fits with the external toothing 662 of FIG. 6 and FIG. 8 of the splined shaft 215 of FIG. 2 through FIG. 6 and FIG. 8.

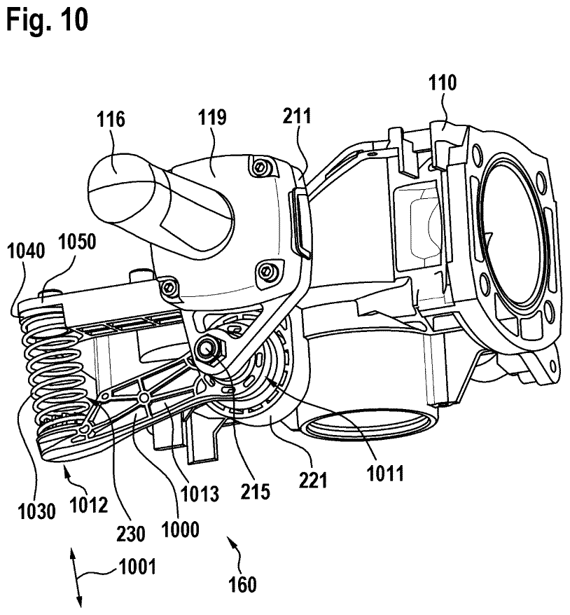

FIG. 10 shows the housing 110 of FIG. 1 through FIG. 7 of the demolition hammer 100 of FIG. 1 and FIG. 2 with an alternative configuration of the anti-vibration system 160. Preferably, the anti-vibration system 160 according to the alternative configuration comprises a connecting rod 1000.

The connecting rod 1000 is preferably arranged along the longitudinal extension 201 of the splined shaft 215 between the intermediate plate 211 of at least one of the two handles 116, 117 and the housing 110, preferably the pivot bearing 650 of FIG. 6. The connecting rod 1000 illustratively comprises a shaft receiving region 1011 and a spring holder region 1012 spaced apart by way of a connecting section 1013 from the shaft receiving region 1011. Preferably, the connecting rod 1000 is rotatably connected to the splined shaft 215 via the shaft receiving region 1011.

The metallic spring element 230 is preferably arranged on the housing 110 and the spring holder region 1012. According to one embodiment, the metallic spring element 230 is a compression spring 1030. In this case, the housing 110 is associated with a spring holder 1040 that attaches the compression spring 1030 to the housing 110. The spring holder 1040 is preferably arranged at a receiving region 1050 of the housing 110. It is noted that the compression spring 1030 may also be arranged directly on the housing 110 without the spring holder 1040.

When pivoting the handle 116 in FIG. 10, or for an arrangement in the end position 500 according to FIG. 5, the compression spring 1030 is preferably compressed along its longitudinal extension 1001 and subsequently presses the handle 116 back into the rest position 400 according to FIG. 4.

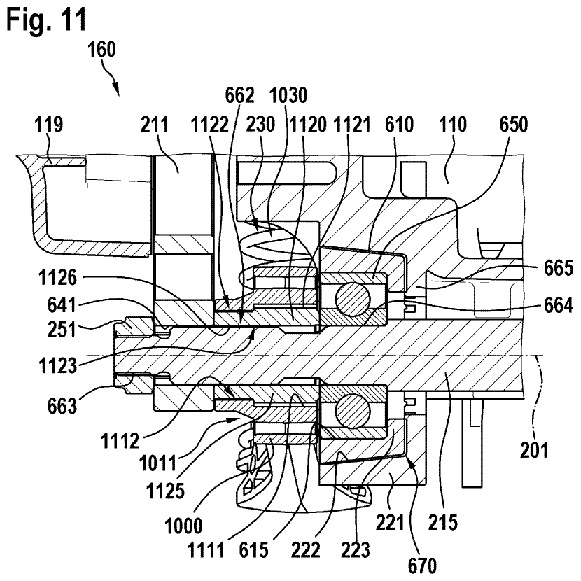

FIG. 11 shows the housing 110 of FIG. 1 through FIG. 7 and FIG. 10 of the demolition hammer 100 of FIG. 1 and FIG. 2 with the anti-vibration system 160 of FIG. 10. FIG. 11 illustrates an exemplary attachment of the connecting rod 1000 to the splined shaft 215 by way of a toothed hub 1120. The connecting rod 1000 is illustratively arranged along the longitudinal extension 201 of the splined shaft 215 between the housing 110 and the intermediate plate 211.

The toothed hub 1120 preferably comprises a cylindrical base body 1125 having an outer circumference 1121, which comprises external toothing in sections 1122. Preferably, the external toothing 1122 is arranged facing the intermediate plate 211. The toothed hub 1120 is illustratively arranged in an inner receptacle 1111 of the connecting rod 1000. Preferably, the internal receptacle 1111 comprises internal toothing 1112 associated with the external toothing 1122. The external toothing 1122 and the internal toothing 1112 are preferably operatively connected.

Furthermore, the toothed hub 1120 exemplarily has internal toothing 1123 on its inner circumference 1126. The internal toothing 1123 is preferably operatively connected to the external toothing 662 of the splined shaft 215.

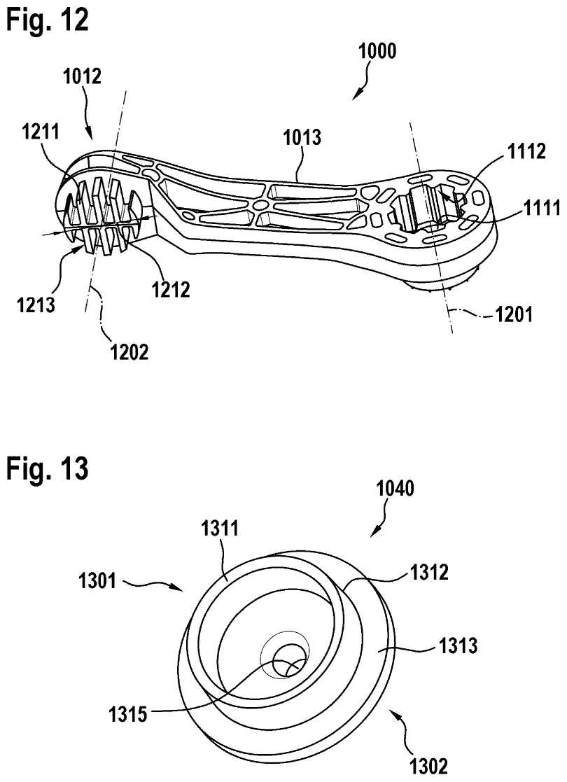

FIG. 12 shows the connecting rod 1000 of FIG. 10 and FIG. 11 with the shaft receiving region 1011 connected to the spring holder region 1012 via the connecting section 1013. FIG. 12 illustrates the internal toothing 1112 arranged in the inner receptacle 1111 of the shaft receiving region 1011.

Furthermore, FIG. 12 illustrates the spring holder region 1012, preferably comprising a holder section 1211 for receiving sections of the compression spring 1030. Preferably, the holder section 1211 is cylindrical in shape and has an outer diameter 1212 associated with an inner diameter of the compression spring 1030 of FIG. 10 and FIG. 11. Illustratively, the holder section 1211 comprises a plurality of individual ridges 1213. A longitudinal axis 1201 associated with the inner receptacle 1111 is preferably arranged perpendicularly to a longitudinal axis 1202 associated with the holder section 1211.

FIG. 13 depicts a side 1301 of the spring holder 1040 of FIG. 10 of the compression spring 1030 of FIG. 10 and FIG. 11 facing the compression spring 1030 when in the assembled state shown in FIG. 10. Preferably, the spring holder 1040 comprises an annular base body 1311 having an outer circumference 1312, into which an inner circumference of the compression spring 1030 can be arranged. On its side 1302 facing away from the compression spring 1030, the spring holder 1040 illustratively comprises a ring collar 1313. Preferably, the ring collar 1313 has a larger diameter than the annular base body 1311. Preferably, the ring collar 1313 has a central recess 1315. The ring collar 1313 serves as the abutment surface of the compression spring 1030 in the assembled state of FIG. 10.

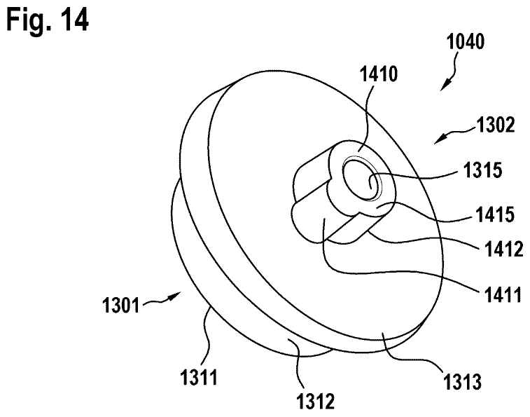

FIG. 14 shows the side 1302 of the spring holder 1040 of FIG. 10 and FIG. 13 facing away from the compression spring 1030 of FIG. 10 and FIG. 11. FIG. 14 illustrates a retaining pin 1410 formed on the ring collar 1313 for arranging the spring holder 1040 on the housing 110 of FIG. 1 through FIG. 7, FIG. 10 and FIG. 11 of the demolition hammer 100 of FIG. 1 and FIG. 2.

Preferably, the retaining pin 1410 has an associated retaining geometry. The retaining geometry comprises, by way of example, a cylindrical ridge 1415 with at least one radial extension ridge 1411. Furthermore, the retaining pin 1410 comprises the central recess 1315 of FIG. 13. An outer circumference 1412 of the retaining pin 1410 is arrangeable in the receiving area 1050 of FIG. 10 of the housing 110.

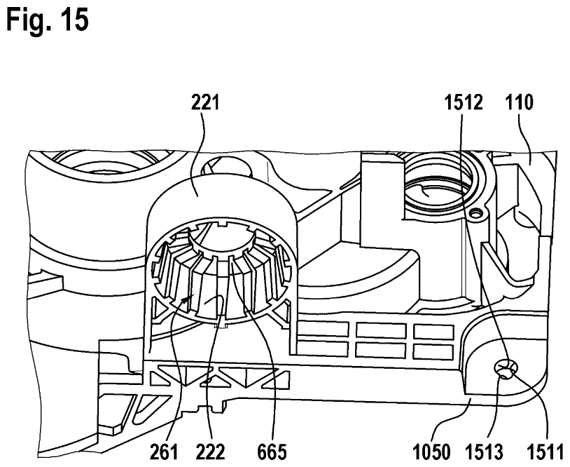

FIG. 15 shows the housing 110 of FIG. 1 through FIG. 7, FIG. 10 and FIG. 11 of the demolition hammer 100 of FIG. 1 and FIG. 2 and illustrates the receiving area 1050 of FIG. 10 for arrangement of the spring holder 1040 of FIG. 10, FIG. 13 and FIG. 14. The receiving area 1050 illustratively comprises a recess 1511 for arrangement of the retaining pin 1410 of FIG. 14 of the spring holder 1040.

The recess 1511 preferably has a shape associated with the retaining geometry of the spring holder 1040 of FIG. 14. Preferably, the recess 1511 comprises a cylindrical section 1512 having at least one radial extension section 1513. Preferably, the retaining pin 1410 and the recess 1511 form an interlocking fit and/or a frictional fit.

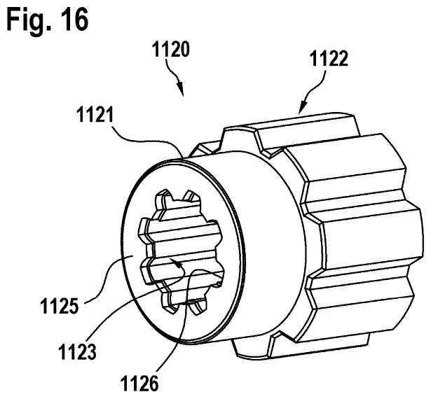

FIG. 16 shows the toothed hub 1120 of FIG. 11 and illustrates its configuration. FIG. 16 shows the preferably cylindrical base body 1125 of the toothed hub 1120 with the external toothing 1122 arranged on the outer circumference 1121 and the internal toothing 1123 arranged on the inner circumference 1126.

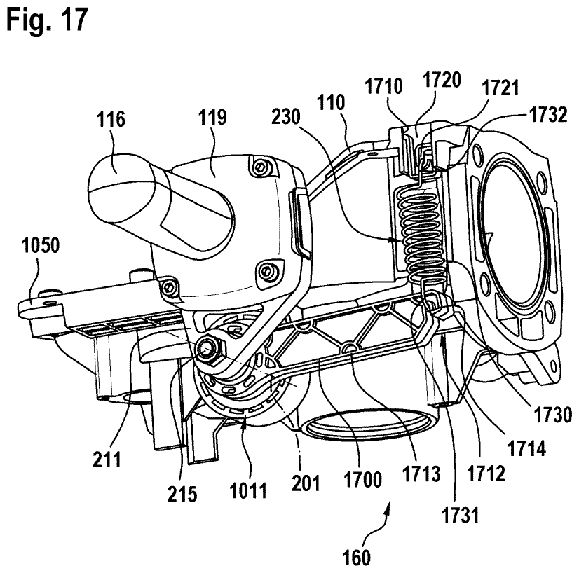

FIG. 17 shows the housing 110 of FIG. 1 through FIG. 7, FIG. 10, FIG. 11, and FIG. 15 of the demolition hammer 100 of FIG. 1 and FIG. 2 with the anti-vibration system 160 configured according to another alternative configuration. Preferably, the anti-vibration system 160 according to the further alternative configuration comprises a connecting rod 1700.

The connecting rod 1700 is illustratively arranged along the longitudinal extension 201 of the splined shaft 215 between the intermediate plate 211 of at least one of the two handles 116, 117 and the pivot bearing 650 of FIG. 6. The connecting rod 1700 has, by way of example, the shaft receiving region 1011 of FIG. 10 and a spring holder region 1712 spaced apart by way of a connecting section 1713 from the shaft receiving region 1011. Preferably, the connecting rod 1700 is rotatably connected to the splined shaft 215 via the shaft receiving region 1011.

Preferably, the metallic spring element 230 is arranged on the housing 110 and the spring holder region 1712. According to one embodiment, the metallic spring element 230 is a tension spring 1730. The spring holder region 1712 preferably comprises a receptacle 1714 for receiving an end 1731 of the tension spring 1730 facing the connecting rod 1700.

Furthermore, a spring holder 1720 is illustratively associated with the housing 110, which spring holder fixes the tension spring 1720 to the housing 110. For this purpose, the spring holder 1720 preferably comprises a receptacle 1721 for receiving an end 1732 of the tension spring 1730 facing the housing 110. The spring holder 1720 is preferably arranged in a receptacle 1710 of the housing 110.

When pivoting the handle 116 in FIG. 17, or for an arrangement in the end position 500 according to FIG. 5, preferably the tension spring 1730 is stretched along its longitudinal extension 1701 and subsequently presses the handle 116 back into the rest position 400 according to FIG. 4.

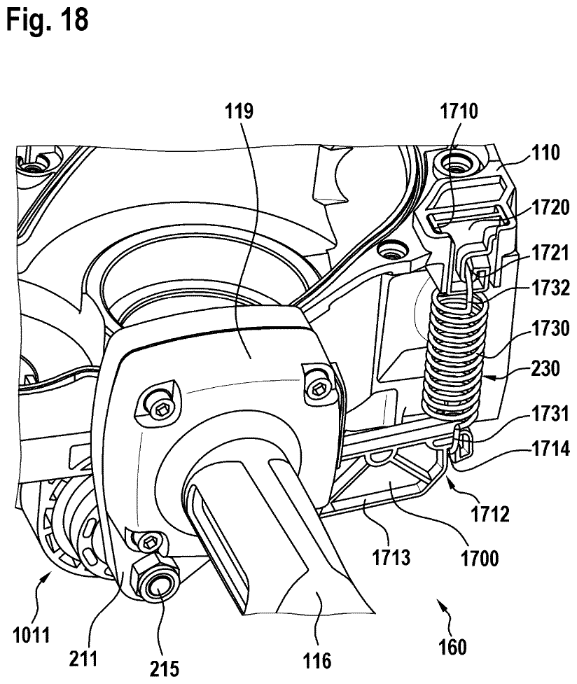

FIG. 18 shows the anti-vibration system 160 with the connecting rod 1700 of FIG. 17. FIG. 18 illustrates the arrangement of the tension spring 1730 with its end 1731 in the receptacle 1714 of the connecting rod 1700 and with its end 1732 in the receptacle 1721 of the spring holder 1720.

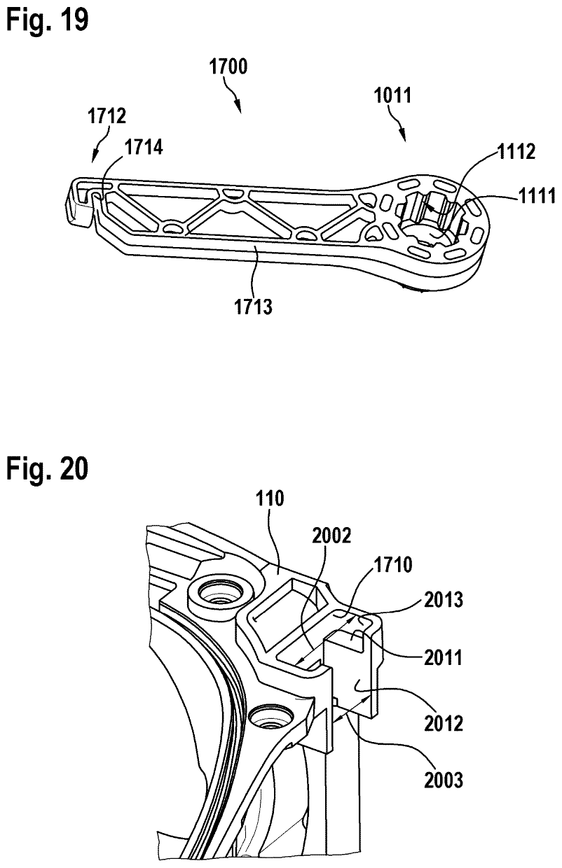

FIG. 19 shows the connecting rod 1700 of FIG. 17 and FIG. 18 with the shaft receiving region 1011 connected to spring holder region 1712 via the connecting section 1713. FIG. 19 illustrates the receptacle 1714 for receiving the first end 1731 of FIG. 17 and FIG. 18 of the tension spring 1730.

FIG. 20 shows the housing 110 of FIG. 17 and FIG. 18 and illustrates the receptacle 1710. The receptacle 1710 has, by way of example, a first, illustratively upper region 2013 and a second, illustratively lower region 2012. The first region 2013 has a first width 2002, which preferably decreases via an abutment surface 2011 into a second width 2003 associated with the second region 2012.

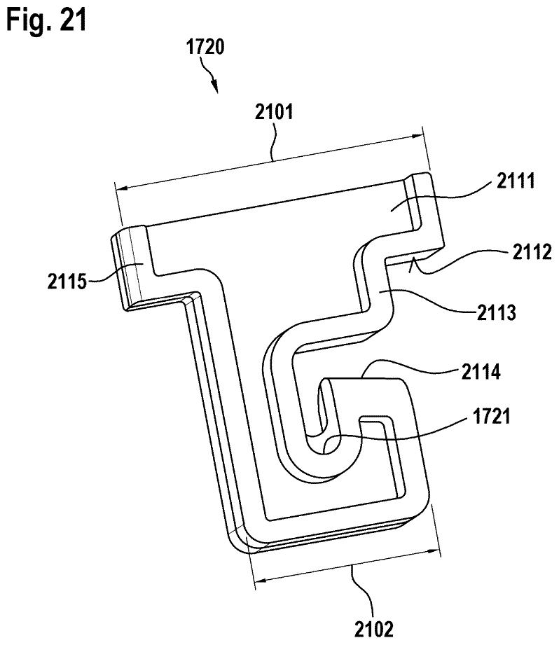

FIG. 21 shows spring holder 1720 of FIG. 17 and FIG. 18. The spring holder 1720 preferably comprises an illustratively upper retaining ridge 2111 for arranging in the first region 2013 of the receptacle 1710 of FIG. 20. The retaining ridge 2111 is exemplary connected to a spring retaining ridge 2113, wherein the spring retaining ridge 2113 comprises the receptacle 1721. Preferably, the receptacle 1721 comprises an L-shaped recess 2114.

The retaining ridge 2111 preferably has a third width 2101, which preferably tapers via abutment surface 2112 into a fourth width 2102 associated with the spring retaining ridge 2113. The third width 2101 of the spring holder 1720 is associated with the first width 2002 of the receptacle 1710 of the housing 110, and the fourth width 2102 of the spring holder 1720 is associated with the second width 2003 of the receptacle 1710. In the assembled state of FIG. 17, the abutment surface 2112 of the spring holder 1720 preferably abuts the abutment surface 2011 of the receptacle 1710 of the housing 110. Furthermore, the spring holder 1720 preferably comprises a reinforcing ridge 2115 along its outer circumference, preferably at least in sections.

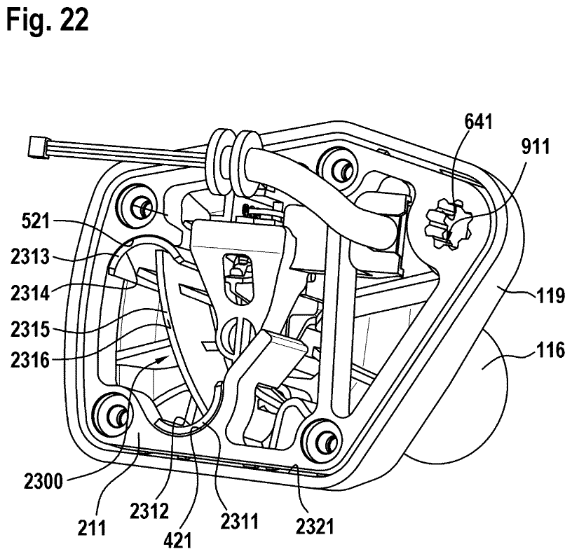

FIG. 22 shows the handle 116 of FIG. 1 through FIG. 6, FIG. 10, FIG. 17, and FIG. 18 with the intermediate plate 211 of FIG. 9 and the flange 119. Preferably, a guide contour 2300 is provided for guiding the two handles 116, 117 from the rest position 400 according to FIG. 4 to the end position 500 according to FIG. 5 and vice versa. Preferably, the guide contour 2300 is associated with the flange 119. The flange 119 preferably comprises an internal receptacle 2321 for receiving the intermediate plate 211. The guide contour 2300 is preferably formed in the inner receptacle 2321.

The guide contour 2300 illustratively comprises a stop bar 2311 associated with the first recess 421 of the intermediate plate 211 with an abutment edge 2312 and a stop bar 2313 associated with the second recess 521 of the intermediate plate 211 with an abutment edge 2314. The two stop bars 2311, 2312 are preferably connected to each other via a guide bar 2315. The guide bar 2315 is illustratively provided for guiding the damping element 410 of FIG. 4 from the rest position 400 according to FIG. 4 to the end position 500 according to FIG. 5, or from the abutment edge 2312 to the abutment edge 2314, and vice versa. The damping element 410 of FIG. 4 is preferably guided on a surface 2316 of the guide bar 2315.

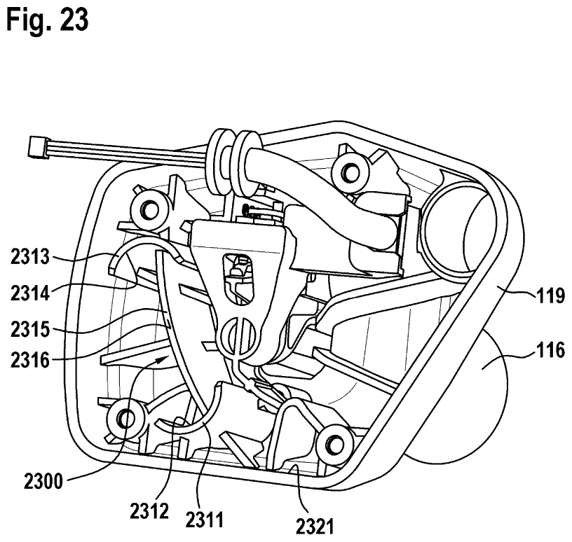

FIG. 23 shows the handle 116 with the flange 119 of FIG. 22. FIG. 23 illustrates the guide contour 2300 with the stop bars 2311, 2313 associated with the intermediate plate 211, with the associated abutment edges 2312, 2314 and the guide bar 2315.

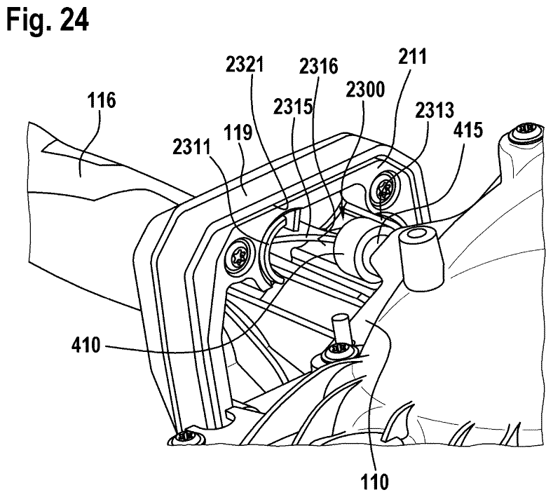

FIG. 24 shows the housing 110 of FIG. 1 through FIG. 7, FIG. 10, FIG. 11, FIG. 15, FIG. 17, FIG. 18, and FIG. 20 of the demolition hammer 100 of FIG. 1 and FIG. 2 with the handle 116 of FIG. 22 and FIG. 23 with the guide contour 2300 of FIG. 22 and FIG. 23. FIG. 24 illustrates the damping element 410 guided on the surface 2316 of the guide bar 2315.

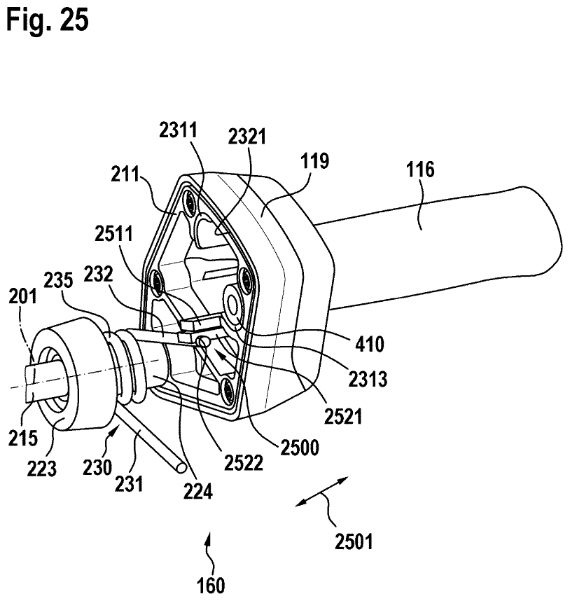

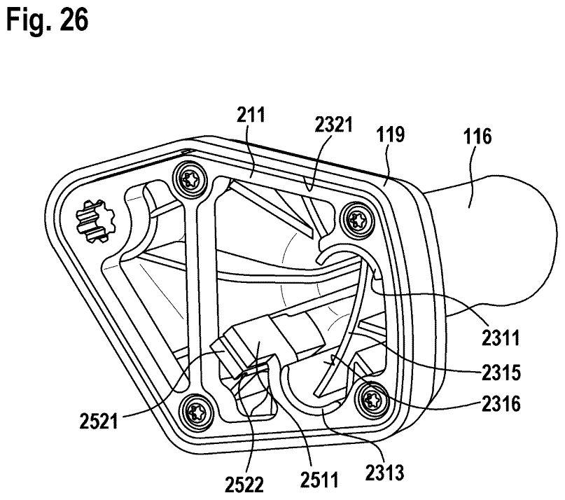

FIG. 25 shows the anti-vibration system 160 of FIG. 2 through FIG. 6 with the leg spring 235 of FIG. 2 through FIG. 6. The leg 232 of the leg spring 235 facing the handle 116 is illustratively arranged on a bar 2521 of the flange 119. For this purpose, the bar 2521 preferably comprises a receptacle 2522. An interlocking fit 2500 is preferably formed between the leg 232 of the leg spring 235 and the handle 116. According to FIG. 25, the interlocking fit 2500 is formed between the leg 232 and the flange 119.

Preferably, the intermediate plate 211 comprises a reinforcing bar 2511 that supports the bar 2521. Preferably, the bar 2521 and the reinforcing bar 2511 are aligned in a parallel manner to the longitudinal extension 201 of the splined shaft 215 and along an arrow 2501. The bar 2521 and the reinforcing bar 2511 are configured as an extension of the flange 119 and the intermediate plate 211 in the direction of the arrow 2501 towards the splined shaft 215.

FIG. 26 shows the handle 116 with the flange 119 and the intermediate plate 211 of FIG. 25. FIG. 26 illustrates the bar 2521 with the receptacle 2522 as well as the reinforcing bar 2511 of the intermediate plate 211.

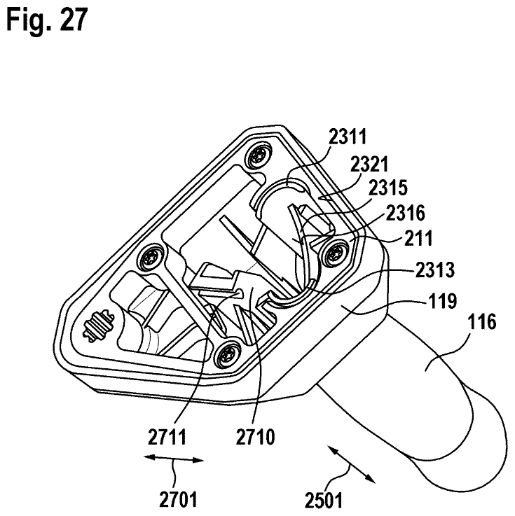

FIG. 27 shows the handle 116, as well as the flange 119 and the intermediate plate 211 of FIG. 25 and FIG. 26, with an alternative bar 2710 for arranging the leg 232 of the leg spring 235. The bar 2710 preferably comprises a receptacle 2711 for this purpose.

Illustratively, the bar 2710 is arranged in a parallel manner to the arrow 2501, wherein the arrow 2501 is parallel to the longitudinal extension 201 of the splined shaft 215, as described above in FIG. 25. The bar 2710 is preferably configured to be stable such that the reinforcing bar 2511 of the intermediate plate 211 of FIG. 25 can be omitted. Furthermore, the receptacle 2711 is illustratively aligned along an arrow 2701 arranged radially to the direction of the arrow 2501. The bar 2710 is preferably configured to hold the leg spring 235 in position and fully support a spring force associated with the leg spring 235 within the handle 116.

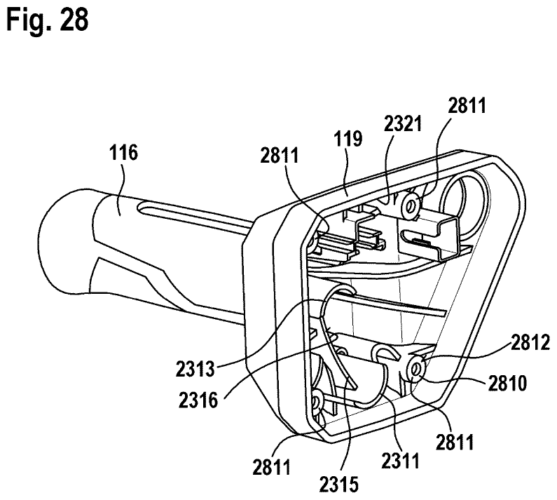

FIG. 28 shows the handle 116 with the flange 119 from FIG. 22 through FIG. 24. The flange 119 illustratively comprises four screw bosses 2811 in its internal receptacle 2321. A surface 2812 of the screw bosses 2811 is preferably each formed as an interlocking element 2810. For example, the interlocking element 2810 forms an interlocking fit with an interlocking element (2910 in FIG. 19) of the intermediate plate 211.

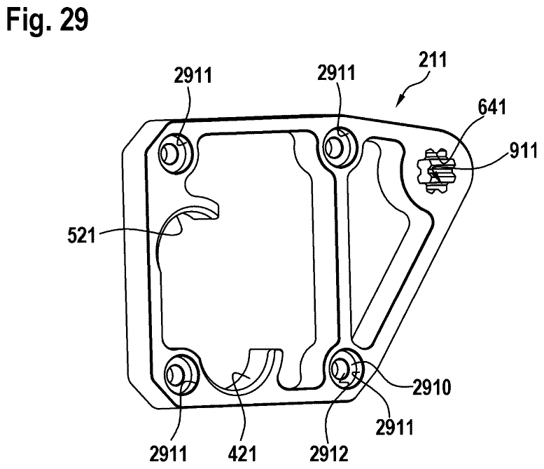

FIG. 29 illustrates the intermediate plate 211 of FIG. 9 and FIG. 22 through FIG. 24. Preferably, the intermediate plate 211 has screw boss receptacles 2911 associated with the screw bosses 2811 of the flange 119 of FIG. 28. The screw boss receptacles 2911 preferably each have a bottom surface 2912. The bottom surface 2912 is preferably configured as an interlocking element 2910. For example, the interlocking element 2910 forms an interlocking fit with the interlocking element 2810 of the flange 119 when assembled.

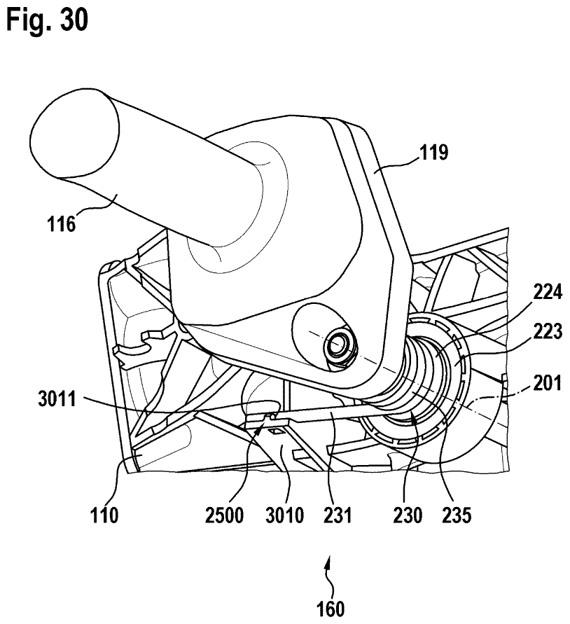

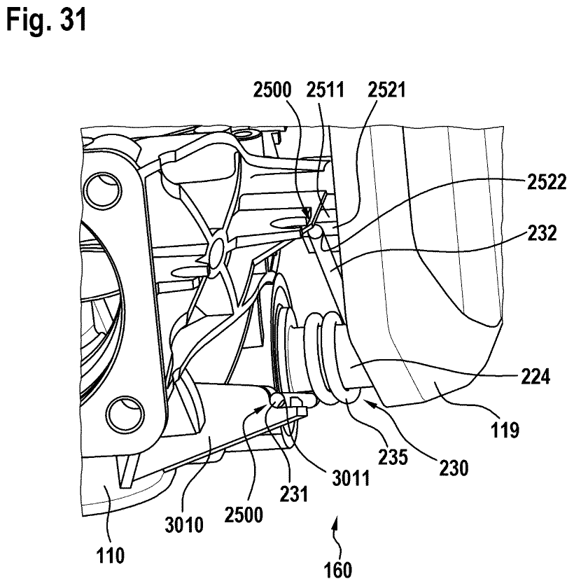

FIG. 30 shows the anti-vibration system 160 of FIG. 1 through FIG. 6 with the leg spring 235 of FIG. 2 through FIG. 6 and FIG. 25. For arrangement of the leg 231 of the leg spring 235 on the housing 110, the housing 110 preferably comprises a bar 3010. The bar 3010 is preferably arranged in a parallel manner to the longitudinal extension 201 of the splined shaft 215. The bar 3010 preferably comprises a receptacle 3011 for partially receiving the leg 231. Preferably, an interlocking fit 2500 is formed between the leg 231 and the housing 110. In FIG. 30, the interlocking fit 2500 is illustratively formed between the receptacle 3011 of the bar 3010 and the leg 231.

FIG. 31 shows the anti-vibration system 160 with the leg spring 235 from FIG. 2 through FIG. 6, FIG. 25 and FIG. 30 with the configuration of the flange 119 and the intermediate plate 211 from FIG. 25 and FIG. 26, as well as the configuration of the housing 110 from FIG. 30. FIG. 31 illustrates the interlocking fit 2500 between the leg 232 of the leg spring 235 and the receptacle 2522 of the flange 119, as well as the interlocking fit 2500 between the receptacles 3011 of the bar 3010 of the housing 110 and the leg 231 of the leg spring 235.

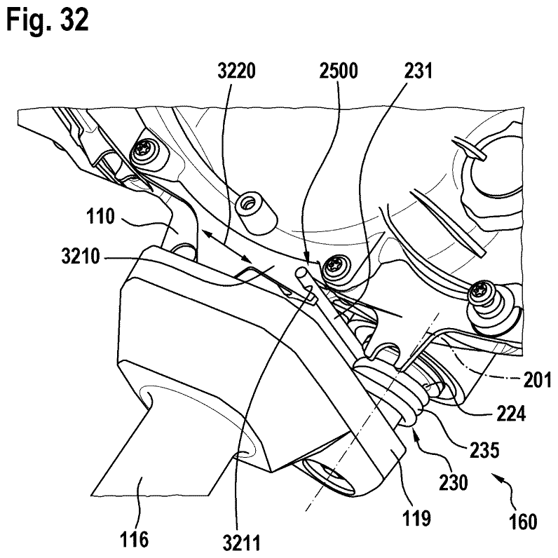

FIG. 32 illustrates the anti-vibration system 160 with the leg spring 235 of FIG. 2 through FIG. 6, FIG. 25, and FIG. 30 through FIG. 31, wherein the housing 110 exemplarily comprises an alternative bar 3210 for arranging the leg 231 of the leg spring 235 on the housing 110. The bar 3210 illustratively comprises a receptacle 3211 for receiving the leg 231. Preferably, an interlocking fit 2500 is formed between the receptacle 3211 and the leg 231. The bar 3210 is preferably arranged along an arrow 3220 on the housing 110, wherein the arrow 3220 is illustratively arranged perpendicularly to the longitudinal extension 201 of the splined shaft 215.

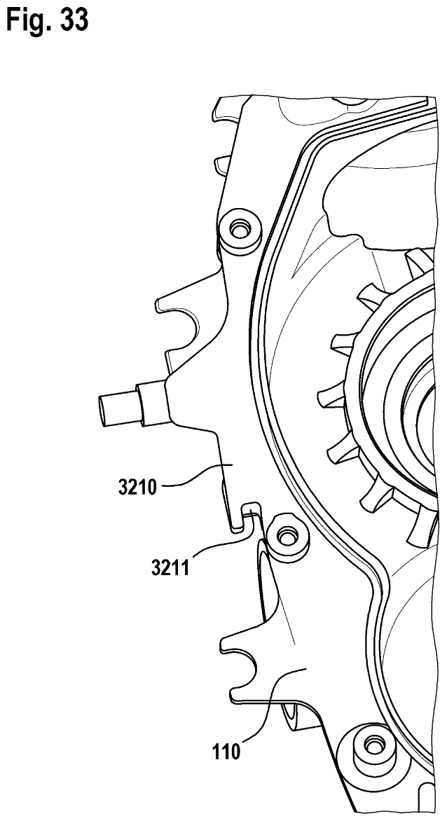

FIG. 33 shows the housing 110 of FIG. 32 with the bar 3210 and the receptacle 3211 for receiving the leg 231 of the leg spring 235.

What is claimed is:

1. A demolition hammer, comprising:
a housing;
two handles arranged on the housing and connected to each other via a splined shaft, wherein the two handles are pivotable about the splined shaft on the housing; and
an anti-vibration system having at least one metallic spring element,
wherein the at least one metallic spring element is operatively connected to the splined shaft, and
wherein the at least one metallic spring element is configured and arranged to apply force to the two handles to push them into an associated rest position.

2. The demolition hammer according to claim 1, wherein:
the housing includes at least one support section with a conical inner receptacle,
a support sleeve is fixed in the conical inner receptacle,
a pivot bearing is arranged in the support sleeve, and
the splined shaft is rotatably supported in the pivot bearing.

3. The demolition hammer according to claim 2, wherein the pivot bearing is arranged along a longitudinal extension of the housing in the housing.

4. The demolition hammer according to claim 2, wherein the conical inner receptacle includes a plurality of radially inwardly facing ribs extending along a longitudinal extension of the splined shaft.

5. The demolition hammer according to claim 1, wherein:
each of the two handles is respectively connected to the splined shaft via an associated intermediate plate,
each intermediate plate comprises a recess with internal toothing, and
the splined shaft has external toothing on its outer circumference which is configured to form an interlocking fit with the internal toothing.

6. The demolition hammer according to claim 5, further comprising at least one damping element fixed to the housing, wherein:
each intermediate plate includes a first recess and a second oppositely located recess,
the damping element is arranged in the first recess in the rest position of the two handles and is arranged in the second recess in an end position of the two handles, and
the two handles are moved between the rest position and the end position by pivoting the two handles about the splined shaft.

7. The demolition hammer according to claim 6, further comprising a guide contour which is configured to guide the two handles from the rest position to the end position and vice versa.

8. The demolition hammer according to claim 2, further comprising a spacer bushing arranged along a longitudinal extension of the splined shaft between the intermediate plate of at least one of the two handles and the pivot bearing, wherein:
the metallic spring element is a leg spring which is arranged on an outer circumference of the spacer bushing,
a first leg of the leg spring is arranged on the housing, and
a second leg of the leg spring is arranged on at least one of the two handles.

9. The demolition hammer according to claim 8, wherein an interlocking fit is formed between the first leg of the leg spring and the housing and/or the second leg of the leg spring and one of the two handles.

10. The demolition hammer according to claim 2, further comprising a connecting rod arranged along a longitudinal extension of the splined shaft between the intermediate plate of at least one of the two handles and the pivot bearing, wherein:
the connecting rod is rotatably connected to the splined shaft at a shaft receiving region and includes a spring holder region spaced apart from the shaft receiving region by way of a connecting section, and
the metallic spring element is arranged on the housing and on the spring holder region.

11. The demolition hammer according to claim 10, wherein the metallic spring element is a compression spring or a tension spring.

12. The demolition hammer according to claim 8, wherein:
the metallic spring element is arranged on the housing by way of a spring holder, and
the metallic spring element is configured as a leg spring or a tension spring.

13. The demolition hammer according to claim 1, wherein the anti-vibration system is arranged within a housing cover with the at least one metallic spring element.

14. The demolition hammer according to claim 1, further comprising a longitudinal extension of a drive shaft associated with a drive motor for operating a tool holder, wherein the longitudinal extension of the drive shaft is arranged perpendicularly to a longitudinal extension of the splined shaft.

15. The demolition hammer according to claim 1, wherein the two handles are each laterally arranged on the housing.
